(19) United States
(12) Patent Application Publication
(10) Pub. No.: US 2007/0296274 A1
(43) Pub. Date: Dec. 27, 2007

(54) Power regulator

(75) Inventors: Chun-Ching Wang, Taipei (TW); Chen-Chia Huang, Taipei (TW); Yu-Hau Hsu, Taipei (TW)

Correspondence Address: BIRCH STEWART KOLASCH & BIRCH, PO BOX 747, FALLS CHURCH, VA, 22040-0747, US

(73) Assignee: Wistron NeWeb Corp.

(21) Appl. No.: 11/589,976

(22) Filed: Oct. 31, 2006

(30) Foreign Application Priority Data
Jun. 23, 2006 (TW) 095122826

(51) Int. Cl. H02J 1/12

(52) U.S. Cl. 307/45

(57) ABSTRACT

The present invention is directed to a power converter, which includes a first switching voltage regulator, some linear voltage regulators, and a second switching voltage regulator. The first switching voltage regulator is electrically connected between input ports and an output terminal. One ends of the linear voltage regulators are respectively electrically connected to the input ports. The second switching voltage regulator is respectively electrically connected between another ends of the linear voltage regulators and the output terminal.

### BACKGROUND OF THE INVENTION

1. Field of the Invention

The present invention generally relates to a power regulator, and more particularly to the power regulator of a satellite low noise block down-converter (LNB).

2. Description of the Prior Art

The user market in satellite communications service is increasingly crucial for its broadband access and availability to all areas. FIG. 1 shows a functional block diagram of a satellite receiving system 10, which primarily includes a low noise block down-converter (LNB) 11, some integrated receiver decoder (IRD) 13A-13M, and corresponding display devices 15A-15M. The LNB 11 is used to decrease the frequency of received satellite signals Sat1-SatN (for example, from a satellite dish), and is illustrated in a more detailed functional block diagram of FIG. 2. Specifically, the LNB 11 primarily includes two blocks: a power regulator 110 and a frequency down-converter 112. The power regulator 110 receives power inputs from the IRD 13A-13M respectively via input ports Port1-PortM, and then performs power regulation or conversion. The frequency down-converter 112 receives the regulated power from the power regulator 110. The frequency of the received satellite signals Sat1-SatN is decreased and these satellite signals are then forwarded to the IRDs 13A-13M via the ports Port1-PortM.

Referring again to FIG. 1, the IRDs 13A-13M send channel selection signals and the power to the LNB 11 via the ports Port1-PortM. In addition, the IRDs 13A-13M receive and demodulate the frequency-decreased satellite signals via the ports Port1-PortM. The demodulated satellite signals are further forwarded to and selectably displayed on the display device 15A-15M respectively.

The LNB 10 as being described above and illustrated in FIG. 1 and FIG. 2 has no power in itself, but rather is dependent on the power supplied from the IRDs 13A-13M. The supplied power from the IRDs 13A-13M is regulated or converted by the power regulator 110 and then provided particularly to the frequency down-converter 112. Nevertheless, the LNB 11 will demand more power commensurate with increased amount of functionality or increased quantity of satellite signals Sat1-SatN. As modern IRDs 13A-13M are manufactured to smaller size, which almost certainly means less power available from the IRDs 13A-13M, the LNB 11 is therefore constrained to expand its functionality. Accordingly, the power conversion efficiency of the power regulator 110 becomes critical in designing the satellite receiving system 10.

FIG. 3A to FIG. 3D show several configurations of conventional power regulator 110 of the LNB 11. FIG. 3A is a partial circuit of the power regulator 110 utilizing linear voltage regulators 1100A-1100M, which receive and then regulate the power supplied from the IRDs 13A-13M, and finally provide the regulated power to the frequency down-converter 112. In this specification, the meaning of the term “linear voltage regulator” conforms to conventional and general usage in electrical engineering. Specifically, the linear voltage regulator is a circuitry that stabilizes the output voltage in a way that the output voltage or portion thereof is fed back to control an element with electrically variable resistance in a form, for example, of a transistor. The “linear” voltage regulator is so named for the reason that the transistor is operated in its linear mode. As known in the field, the linear voltage regulators such as the linear voltage regulators 1100A-1100M of FIG. 3A have poor conversion efficiency and thus are not suitable for a system that demands high power.

FIG. 3B is a partial circuit of the power regulator 110 utilizing switching voltage regulators 1102A-1102M, which receive and then regulate the power supplied from the IRDs 13A-13M, and finally provide the regulated power to the frequency down-converter 112. In this specification, the meaning of the term “switching voltage regulator” conforms to conventional and general usage in electrical engineering. Specifically, the switching voltage regulator is a circuitry that stabilizes the output voltage in a way that an adjustable duty-cycle signal is generated according to the output voltage or portion thereof to control a switching element in a form, for example, of a transistor. The “switching” voltage regulator is so named for the reason that the transistor is operated in its switching or on-off mode. Compared to the linear voltage regulators, the switching voltage regulators 1102A-1102M of FIG. 3B have better conversion efficiency. However, the switching voltage regulators 1102A-1102M require larger area and cost more, and therefore the power regulator 110 of FIG. 3B suffers the disadvantage of higher cost.

FIG. 3C is a partial circuit of the power regulator 110 utilizing both linear voltage regulators 1104A-1104M and a switching voltage regulator 1106. Accordingly, the power regulator 110 of FIG. 3C has advantages of better conversion efficiency, lower cost, and less area. However, the input voltage of the switching voltage regulator 1106 is disadvantageously constrained by the output voltage of the linear voltage regulators 1104A-1104M. In other words, the voltage difference across the input terminal and output terminal of the switching voltage regulator 1106 is too small so that the switching voltage regulator 1106 could not reach its optimal conversion efficiency.

FIG. 3D is a partial circuit of the power regulator 110 utilizing a switching voltage regulator 1106 without linear voltage regulator, thereby overcoming the disadvantage of FIG. 3C. Nevertheless, the power regulator 110 becomes an unbalanced circuitry, for example, when one of the input voltages of the ports Port1-PortM is greater than the others and thus almost all power to the switching voltage regulator 1106 is exclusively supplied by that sole port.

For the reasons discussed above, a need has arisen to propose a power regulator that is not only a balanced circuitry but also has low cost, small area, and good conversion efficiency, therefore competitively being capable of coping with more demand in satellite communications service.

### SUMMARY OF THE INVENTION

In view of the foregoing, it is an object of the present invention to provide a power regulator that both is a balanced circuitry and has good conversion efficiency.

According to the object, the present invention provides a power converter, which includes a first switching voltage regulator, some linear voltage regulators, and a second switching voltage regulator. The first switching voltage regulator is electrically connected between input ports and an output terminal. One ends of the linear voltage regulators are respectively electrically connected to the input ports. The second switching voltage regulator is respectively electrically connected between another ends of the linear voltage regulators and the output terminal.

### BRIEF DESCRIPTION OF THE DRAWINGS

FIG. 1 shows a functional block diagram of a satellite receiving system;

FIG. 2 shows a detailed functional block diagram of the LNB of FIG. 1;

FIG. 3A to FIG. 3D show several configurations of conventional power regulator of the LNB;

FIG. 4A shows a power regulator according to the embodiment of the present invention;

FIG. 4B is a partial circuit of the power regulator of FIG. 4A; and

FIG. 5 is a partial circuit of a conventional power regulator similar to that of FIG. 3C.

### DETAILED DESCRIPTION OF THE INVENTION

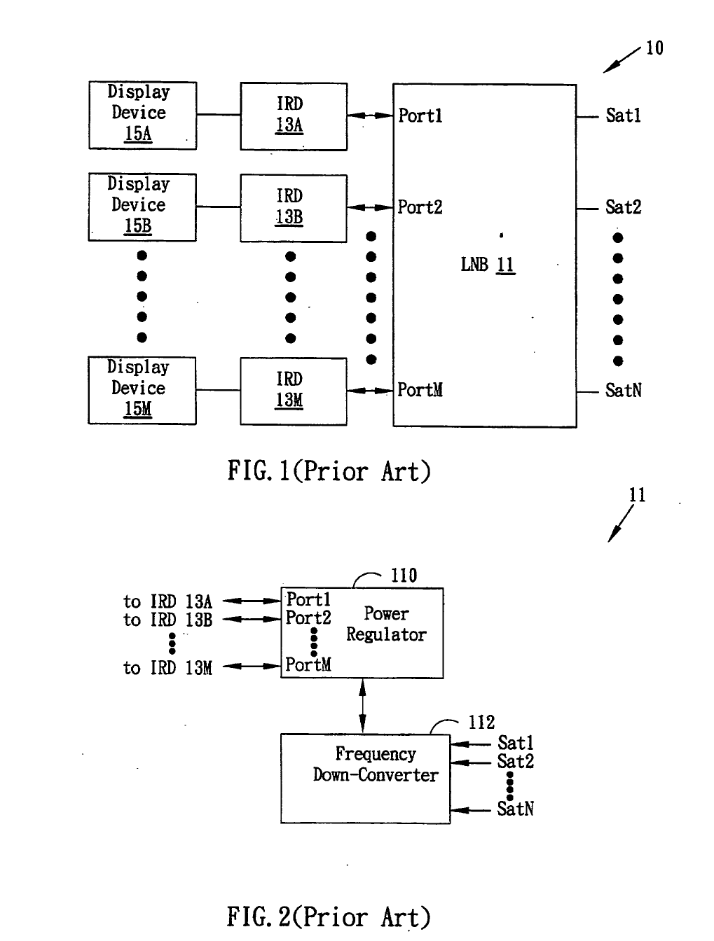

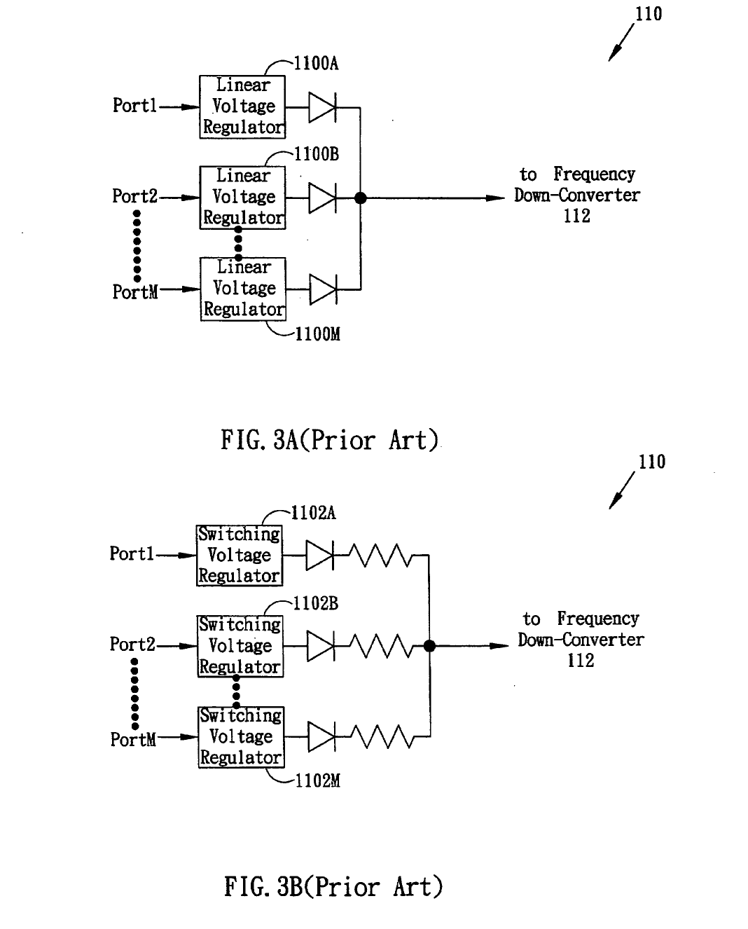

The embodiment of the present invention is exemplified by a satellite receiving system, which has similar functional block diagrams as in FIG. 1 and FIG. 2 and is thus not repeatedly described and illustrated herein, except for the power regulator (110 of FIG. 2). Although the power regulator of the present embodiment is adapted for the low noise block down-converter (LNB) 11 of the satellite receiving system 10, the present invention, however, could be adapted for other electronic systems, particularly a system in which power supplies are constrained and/or the system demands more power commensurate with increased functionality.

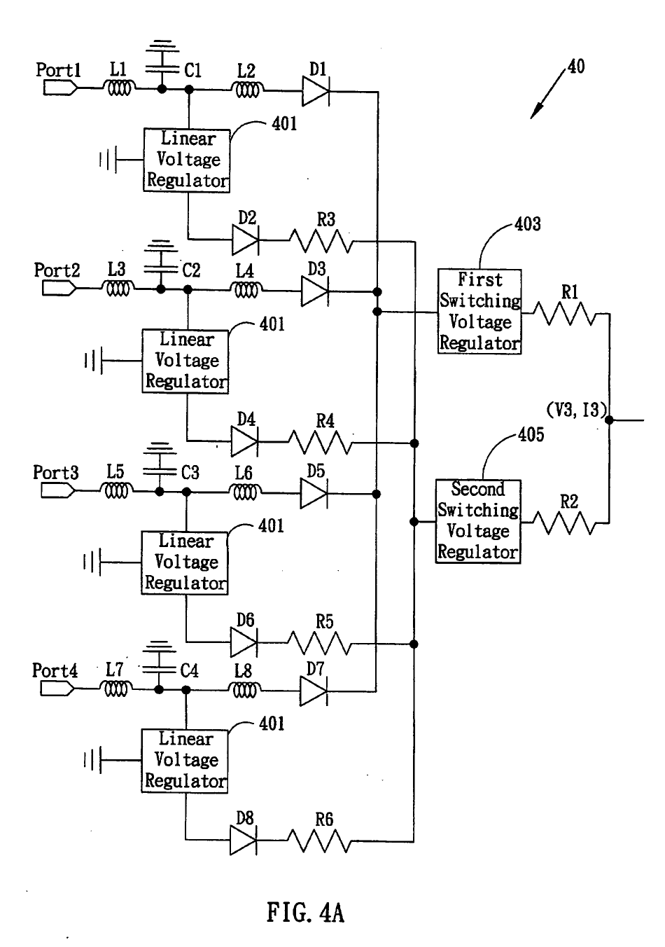

FIG. 4A shows a power regulator 40 according to the embodiment of the present invention. In this embodiment, the power regulator 40 receives power inputs from the integrated receiver decoder (IRD, e.g., 13A, 13B . . . of FIG. 1) respectively via ports Port1-Port4, and then performs power regulation or conversion. The frequency down-converter 112 (FIG. 2) receives the regulated power from the power regulator 40. It is appreciated that the quantity of the input ports is not limited to four (4) as in this embodiment.

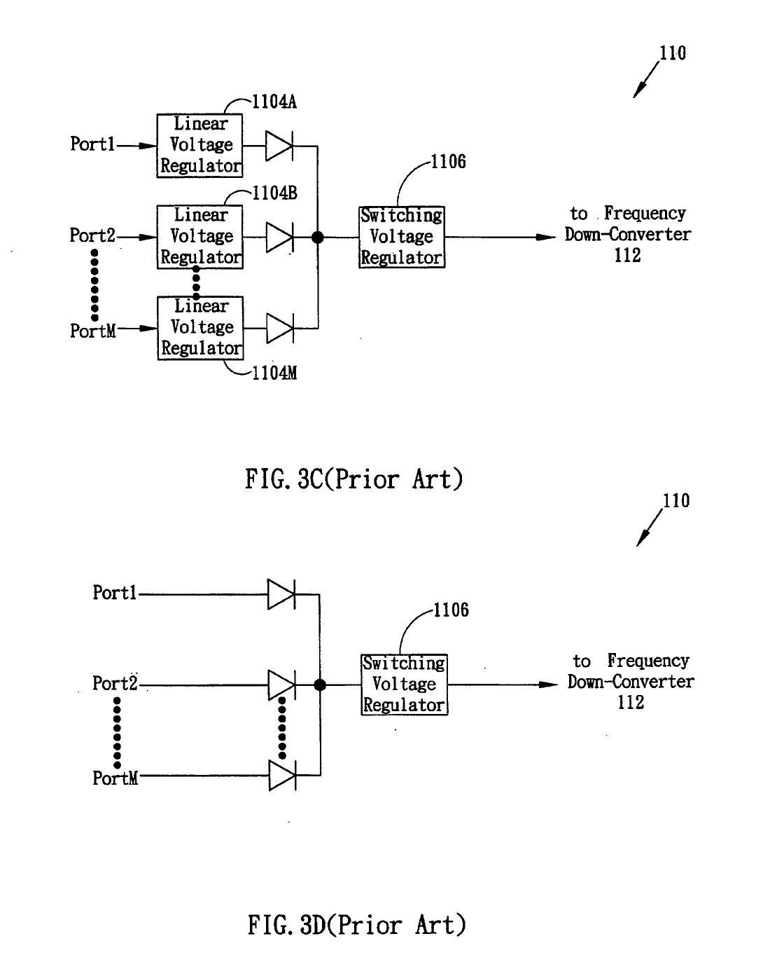

FIG. 4B is a partial circuit 40′ associated with one port of the power regulator 40 of FIG. 4A. The power regulator 40′ associated with each input port primarily includes a linear voltage regulator 401, a first switching voltage regulator 403, and a second switching voltage regulator 405. The first switching voltage regulator 403 is electrically connected between the input port Port1 and an output terminal A; and the linear voltage regulator 401 and the second switching voltage regulator 405 are cascaded and collectively electrically connected between the input port Port1 and the output terminal A. In this specification, the term “electrically connected” means two or more electronic elements or devices are electrically communicated, but not limited to directly or physically connection. The power input entering into the port Port1 is regulated by the linear voltage regulator 401, which outputs a fixed voltage, for example, of nine (9) volts. The first switching voltage regulator 403 and the second switching voltage regulator 405 have better conversion efficiency than the linear voltage regulator 401. Further, the first switching voltage regulator 403 is more better than the second switching voltage regulator 405 because the first switching voltage regulator 403 has greater voltage difference across its input terminal and output terminal, while the input voltage of the second switching voltage regulator 405 is disadvantageously constrained by the output voltage of the linear voltage regulator 401. In addition to the linear voltage regulator 401, the first switching voltage regulator 403, and the second switching voltage regulator 405, the power regulator 40′ further includes a first resistor R1 and a second resistor R2, where the first resistor R1 is electrically connected between the first switching voltage regulator 403 and the output terminal A; and the second resistor R2 is electrically connected between the second switching voltage regulator 405 and the output terminal A. The allocation between the currents I1 and I2 flowing the first resistor R1 and the second resistor R2 could be made by adjusting resistances of the first resistor R1 and the second resistor R2. Compared to the conventional power regulators 110 of FIGS. 3A-3D, the power regulator 40′ of the present embodiment advantageously possesses current allocatability and obtains better conversion efficiency to provide greater output current I3 for the frequency down-converter 112 (FIG. 2).

The power regulator 40 of FIG. 4A further includes diodes D1-D8 for directing the input voltages or signals from the ports port1-Port4 in a specific direction, and thus for preventing miscommunications among the ports Port1-Port4. Specifically, some first diodes (D1, D3, D5, and D7) are respectively electrically connected between the ports Port1-Port4 and the first switching voltage regulator 403 so that the signal, for example, entering the port Port1 is directed in a specific path toward the first switching voltage regulator 403, and thus preventing the signal from erroneously heading for the other port Port2, Port3, or Port4. Likewise, some second diodes (D2, D4, D6, and D8) are respectively electrically connected between the linear voltage regulator 401 and the second switching voltage regulator 405 so that the signal, for example, out of the linear voltage regulator 401 of the port Port1 is directed in a specific path toward the second switching voltage regulator 405, and thus preventing the signal from erroneously heading for the linear voltage regulator 401 of other port Port2, Port3, or Port4.

Referring to FIG. 4B, the input port Port1 is used for receiving power as described above; in addition, the same port Port1 is also used for receiving channel selection signals. There are generally two types of channel selection signals: high-voltage channel selection signals and low-voltage channel selection signals. In a conventional satellite receiving system, for example, a signal located within 14.5-21 volts (V) is defined as high-voltage channel selection signal, and a signal located within 9.5-14V is defined as low-voltage channel selection signal. Accordingly, in a (15V, 11V) system, the high-voltage channel selection signal (15V) and the low-voltage channel selection signal (11V) are collectively utilized to select one of two available satellite channels. Moreover, in the conventional satellite receiving system, some of the high-voltage channel selection signals or the low-voltage channel selection signals are merged with a low-frequency pulse signal (such as 22 k hertz pulse signal). As a result, there become four types of channel selection signals (i.e., pure low-voltage channel selection signals, low-voltage channel selection signals merged with pulse signal, pure high-voltage channel selection signals, and high-voltage channel selection signals merged with pulse signal) for selecting one of four available satellite channels. Referring to FIG. 4A, inductors L1-L8, capacitors C1-C4, and resistors R3-R6 are used for detecting the low-frequency pulse signal. The operation of this detection uses technique well known in the field, and its discussion is thus omitted here.

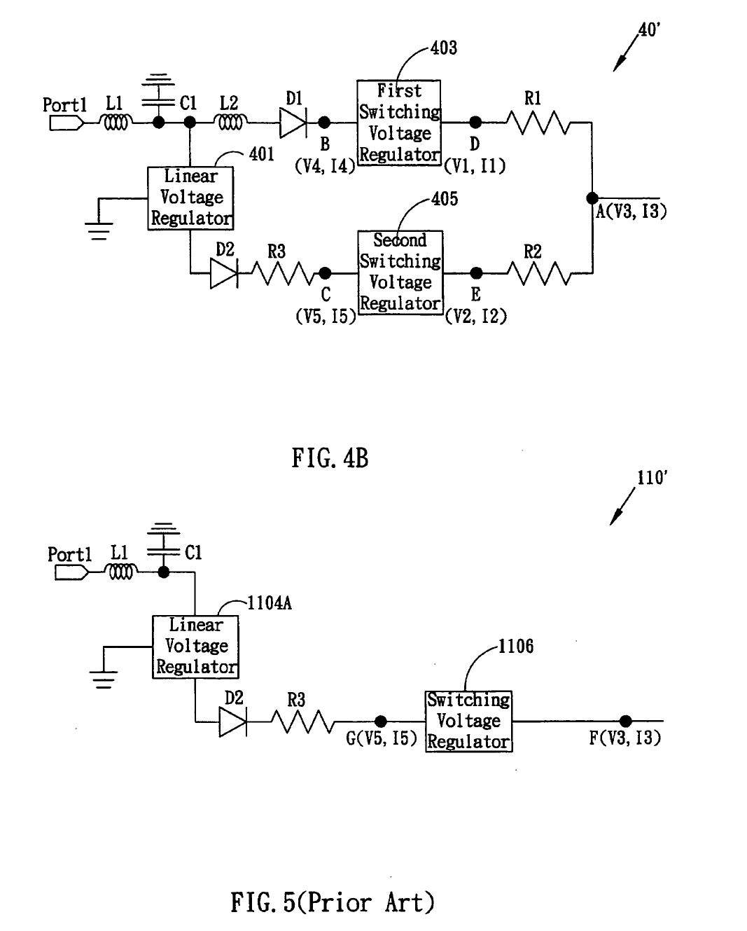

For better appreciating the effect of the present embodiment, the conversion efficiency of the power regulator 40′ of the present embodiment (FIG. 4B) and the conversion efficiency of the conventional power regulator 110′ of FIG. 5 (which is a partial circuit of a conventional power regulator similar to that of FIG. 3C) are explained and compared.

Referring to FIG. 4B, the input voltage entering the port Port1 is assumed 15V, the output voltage V3 at the output terminal A is assumed 5V, and the requisite output current I3 is assumed 800 mini Ampere (mA). The voltage V4 at node B becomes 14.4V due to the voltage drop across the diode D1, and the current I4 flowing through the node B has an initial value. Similarly, the voltage V5 at node C becomes 8.4V due to the voltage drop through the linear voltage regulator 401, the diode D2, and the resistor R3, and the current I5 flowing through the node C has an initial value. In designing such circuit, a designer could determine the outputs of the first switching voltage regulator 403 and the second switching voltage regulator 405 according to the voltages (V4, V5) and currents (I4, I5). In this embodiment, the voltage V1 at node D is determined to be 5.6V, and the voltage V2 at node E is determined to be 5.5V. Moreover, the current I1 is allocated 600 mA and the current I2 is allocated 200 mA (the allocation of the currents will be further described later.) Based on the following electric equations (1) and (2):

(V1−V3)/I1=R1 (1)

(V2−V3)/I2=R2 (2)

the resistance of the resistor R1 is thus 1 ohm (Ω), and the resistance of the resistor R2 is 2.5Ω.

Subsequently, based on the known conversion equations and the derived currents I1 and I2:

V4*I4*efficiency=V1*I1 (3)

V5*I5*efficiency=V2*I2 (4)

where V4=14.4V, V5=8.4V, efficiency is assumed 80%, V1=5.6V, V2=5.5V, I1=600 mA, and I2=200 mA, we therefore come up with I4=291 mA and I5=163 mA. Accordingly, the power regulator 40′ demands input current of 454 mA (=I4+I5) in order to generate the requisite output current I3 of 800 mA at the node A.

To sum up the circuit design procedure discussed above, firstly assume the output voltage V3 and the output current I3, followed by deriving the voltages and the currents at the nodes B and C, and the voltage at the nodes D and E. According to the current allocation between the upper path (i.e., I1) and the lower path (i.e., I2), the resistances of the resistor R1 and the resistor R2 are thus determined. Finally, based on the conversion equations, the currents (I4, I5) and thus the demanding input current is attained.

Regarding the current allocation between the upper path and the lower path, a higher percentage of current is allocated to the upper path than the lower path when the output current I3 is high enough, because the first switching voltage regulator 403 in the upper path has a higher conversion efficiency than the second switching voltage regulator 405 in the lower path. When the output current I3 is not high enough, the percentage of current allocated to the upper path is close to the percentage of current allocated to the lower path. For example, the current I1 is allocated 600 mA and the current I2 is allocated 200 mA (i.e., I1:I2=3:1) when the output current I3 is 800 mA; and the current I1 is allocated 400 mA and the current I2 is allocated 200 mA (i.e., I1:I2=2:1) when the output current I3 is 600 mA.

To the other hand, the conversion efficiency of the conventional power regulator 110′ of FIG. 5 is now explained and compared to that of FIG. 4B. First of all, the input voltage entering the port Port1 is assumed 15V, the output voltage V3 at the output terminal F is assumed 5V, and the requisite output current I3 is assumed 800 mA. The voltage V5 at node G becomes 8.4V due to the voltage drop through the linear voltage regulator 1104A, the diode D2, and the resistor R3. Based on the known conversion equation (5) and assumed conversion efficiency of 80%:

V5*I5*efficiency=V3*I3 (5)

we therefore have input current I5 of 595 mA for the switching voltage regulator 1106. In other words, the conventional power regulator 110′ demands input current of 595 mA (instead of 454 mA as in FIG. 4B) in order to generate the requisite output current I3 of 800 mA at the node F. Compared to the circuit of FIG. 4B, the embodiment of the present invention as depicted in FIG. 4B possesses better conversion efficiency. To put it in another way, provided with the same input currents for the power regulator 40′ of the present embodiment and the conventional power regulator 110′, the power regulator 40′ of the present embodiment will generate more output current, which is better adapted for satellite communications services or other electronic systems equipped with more functionality.

Although specific embodiments have been illustrated and described, it will be appreciated by those skilled in the art that various modifications may be made without departing from the scope of the present invention, which is intended to be limited solely by the appended claims.

What is claimed is:

1. A power regulator, comprising:
a plurality of input ports for respectively receiving power;
an output terminal for providing regulated power;
a first switching voltage regulator, being electrically connected between one of the input ports and the output terminal;
a plurality of linear voltage regulators, being respectively electrically connected to the input ports at one ends of said linear voltage regulators; and
a second switching voltage regulator, being respectively electrically connected between another ends of said linear voltage regulators and the output terminal.

2. The power regulator according to claim 1, further comprising a plurality of first diodes respectively electrically connected between the input ports and said first switching voltage regulator, for directing signals in a path toward said first switching voltage regulator.

3. The power regulator according to claim 1, further comprising a plurality of second diodes respectively electrically connected between said linear voltage regulators and said second switching voltage regulator, for directing signals out of said linear voltage regulators respectively in a path toward said second switching voltage regulator.

4. The power regulator according to claim 1, further comprising a first resistor electrically connected between said first switching voltage regulator and the output terminal.

5. The power regulator according to claim 4, further comprising a second resistor electrically connected between said second switching voltage regulator and the output terminal.

6. A power regulator of a satellite receiving system, comprising:
a plurality of input ports for respectively receiving power from a plurality of integrated receiver decoders (IRDs);
an output terminal for providing regulated power to a frequency down-converter;
a first switching voltage regulator, being electrically connected between one of the input ports and the output terminal;
a plurality of linear voltage regulators, being respectively electrically connected to the input ports at one ends of said linear voltage regulators; and
a second switching voltage regulator, being respectively electrically connected between another ends of said linear voltage regulators and the output terminal.

7. The power regulator of a satellite receiving system according to claim 6, further comprising a plurality of first diodes respectively electrically connected between the input ports and said first switching voltage regulator, for directing signals in a path toward said first switching voltage regulator.

8. The power regulator of a satellite receiving system according to claim 6, further comprising a plurality of second diodes respectively electrically connected between said linear voltage regulators and said second switching voltage regulator, for directing signals out of said linear voltage regulators respectively in a path toward said second switching voltage regulator.

9. The power regulator of a satellite receiving system according to claim 6, further comprising a first resistor electrically connected between said first switching voltage regulator and the output terminal.

10. The power regulator of a satellite receiving system according to claim 9, further comprising a second resistor electrically connected between said second switching voltage regulator and the output terminal.

11. A satellite receiving system, comprising:
a plurality of integrated receiver decoders (IRDs) for respectively providing power;
a low noise block down-converter (LNB), receiving a plurality of satellite signals, said LNB including a power regulator which comprises:
a plurality of input ports for respectively receiving power;
an output terminal for providing regulated power;
a first switching voltage regulator, being electrically connected between one of the input ports and the output terminal;
a plurality of linear voltage regulators, being respectively electrically connected to the input ports at one ends of said linear voltage regulators; and
a second switching voltage regulator, being respectively electrically connected between another ends of said linear voltage regulators and the output terminal.

12. The satellite receiving system according to claim 11, further comprising a plurality of display devices respectively electrically connected to said IRDs.

13. The satellite receiving system according to claim 11, wherein said LNB further comprise a frequency down-converter which receives the regulated power and decreases frequency of the satellite signals.

14. The satellite receiving system according to claim 11, further comprising a plurality of first diodes respectively electrically connected between the input ports and said first switching voltage regulator, for directing signals in a path toward said first switching voltage regulator.

15. The satellite receiving system according to claim 11, further comprising a plurality of second diodes respectively electrically connected between said linear voltage regulators and said second switching voltage regulator, for directing signals out of said linear voltage regulators respectively in a path toward said second switching voltage regulator.

16. The satellite receiving system according to claim 11, further comprising a first resistor electrically connected between said first switching voltage regulator and the output terminal.

17. The satellite receiving system according to claim 16, further comprising a second resistor electrically connected between said second switching voltage regulator and the output terminal.
